(19) United States
(12) Patent Application Publication
(10) Pub. No.: US 2026/0355962 A1
(43) Pub. Date: Nov. 12, 2026

(54) MOBILE DOCKABLE COLLABORATIVE ROBOT CART

(71) Applicant: IME AUTOMATION, INC, Hurricane, UT (US)

(72) Inventors: Riley WHITE, Hurricane, UT (US); Leo WRIGHT, LaVerkin, UT (US); Caleb Gregory WRIGHT, Hurricane, UT (US); Dennis LATYSHEV, Hurricane, UT (US)

(73) Assignee: IME AUTOMATION, INC, Hurricane, UT (US)

(21) Appl. No.: 19/675,416

(22) Filed: May 12, 2026

Related U.S. Application Data
(60) Provisional application No. 63/804,566, filed on May 12, 2025.
(60) Provisional application No. 63/813,203, filed on May 28, 2025.

(51) Int. Cl. B25J 9/16; B25J 5/00; B60T 1/12; G06K 7/10

(52) U.S. Cl. CPC B25J 9/1674; B25J 5/007; B60T 1/12; G06K 7/10366

(57) ABSTRACT

A system can include a mobile robotic apparatus and a receiving station. The mobile robotic apparatus can include a cart, a robotic manipulator, and a coupling mechanism. The cart can have a device for allowing the cart to be mobile. The robotic manipulator can be coupled with the cart and can include an end effector for interacting with an item. The coupling mechanism can be located on the cart and can couple the cart to a receiving station. The receiving station can be located in an operating environment and can be sized to couple with the coupling mechanism to facilitate operation of the robotic manipulator.

### CROSS-REFERENCE TO RELATED APPLICATIONS

This application claims the benefit of U.S. Provisional Application No. 63/804,566, filed May 12, 2025, titled “MOBILE DOCKABLE COLLABORATIVE ROBOT CART,” and of U.S. Provisional Application No. 63/818,203, filed Jun. 5, 2025, titled “AUTONOMOUS MOVEMENT OF A MOBILE DOCKABLE COLLABORATIVE ROBOT CART,” the entire contents of each of which are hereby incorporated in their entirety for all purposes.

### FIELD

The present disclosure relates generally to tools for robotic operations, and more particularly (although not necessarily exclusively), to a mobile dockable collaborative robot cart.

### BACKGROUND

In the field of robotic operations, many programs must be compiled or loaded onto a robotic apparatus after being selected such as by an operator. This is a slow process and does not lend itself to flexibility in a production environment that uses robotics.

### SUMMARY

In some embodiments, an apparatus can include a cart, a robotic manipulator, and a coupling mechanism. The cart can have a device for allowing the cart to be mobile. The robotic manipulator can be coupled with and can extend from the cart. The robotic manipulator can include an end effector for interacting with an item at a receiving station. The coupling mechanism can be located on the cart. The coupling mechanism can couple the cart to a floor plate of the receiving station located on a floor of an operating environment for facilitating operation of the robotic manipulator. The coupling mechanism can include a set of sensors to facilitate automatic execution of an operational mode of the robotic manipulator.

In some embodiments, the set of sensors can include a safety-rated proximity sensor. The safety-rated proximity sensor can be located on an underside of the cart, and the safety-rated proximity sensor can be arranged to engage with a corresponding safety-rated proximity sensor located on the floor plate. Additionally, or alternatively, the safety-rated proximity sensor can engage with the corresponding safety-rated proximity sensor when the cart is successfully coupled with the floor plate, and the operational mode can be prevented when the safety-rated proximity sensor is not engaged with the corresponding safety-rated proximity sensor. Additionally, or alternatively, the safety-rated proximity sensor can include a housing and a plurality of sections spaced apart within the housing. Each section of the plurality of sections can interact with a corresponding section of the corresponding safety-rated proximity sensor, and the safety-rated proximity sensor is engaged with the corresponding safety-rated proximity sensor when each section of the plurality of sections interacts with each corresponding section of the corresponding safety-rated proximity sensor.

In some embodiments, the set of sensors can include an identification sensor. The identification sensor can be located on an underside of the cart, and the identification sensor can be arranged to engage with a corresponding identification sensor located on the floor plate. Additionally, or alternatively, the identification sensor can include an RFID transmitter that can interact with the corresponding identification sensor to receive information about the receiving station. The information can include at least one of a location of the receiving station within the operating environment, a type of operation performable at the location, or a list of available operational modes at the location. Additionally, or alternatively, the identification sensor can be communicatively coupled with a controller that can operate the robotic manipulator. The identification sensor can transmit the information to the controller to facilitate a decision by the controller to automatically execute the operational mode, and the operational mode can be included in the list of available operational modes.

In some embodiments, the set of sensors can include a plurality of safety-rated sensors and an identification sensor. A safety-rated proximity sensor of the plurality of safety-rated sensors and the identification sensor can be located spaced apart on an underside of the cart to engage with corresponding sensors located on the floor plate. A safety-rated pressure sensor of the plurality of safety-rated sensors can be located within a slot of the coupling mechanism to engage when a post from the floor plate protrudes into the slot to indicate when the cart is locked into the floor plate. Additionally, or alternatively, the device can include a plurality of casters and a plurality of wheels. Wheels of the plurality of wheels can be directionally fixed and positioned on an end of the cart to receive movement force, and casters of the plurality of casters can be directionally variable and positioned on an end of the cart opposite the end of the cart configured to receive the movement force. Additionally, or alternatively, the cart can define a plurality of lifting slots. Each lifting slot of the plurality of lifting slots can be approximately parallel to other lifting slots of the plurality of lifting slots. Each lifting slot of the plurality of lifting slots can be formed on an underside of the cart, and the plurality of lifting slots can be positioned around and spaced apart from the coupling mechanism.

In some embodiments, the coupling mechanism can include a restriction mechanism and a latching mechanism. The restriction mechanism can passively prevent lateral movement of the cart while the cart is coupled with the floor plate, and the latching mechanism can apply a coupling force to couple the cart with the floor plate. Additionally, or alternatively, the restriction mechanism can include a plurality of posts. Each post of the plurality of posts can extend below a bottom of the cart, and each post of the plurality of posts can be arranged to slide into a corresponding slot of a plurality of slots of the floor plate. Additionally, or alternatively, the latching mechanism can include a clamp that extends below the bottom of the cart between the plurality of posts. The clamp can be arranged to engage with a protrusion extending from the floor plate, and the clamp can apply the coupling force when engaged with the protrusion.

In some embodiments, a system can include a floor plate and a mobile robotic apparatus. The floor plate can be configured for mounting to a floor of a receiving station of an operating environment. The floor plate can include a first coupling mechanism and a first set of sensors. The mobile robotic apparatus can include a cart, a robotic manipulator, and a second coupling mechanism. The cart can have a device for allowing the cart to be mobile. The robotic manipulator can be coupled with and can extend from the cart. The robotic manipulator can include an end effector for interacting with an item that at a receiving station. The second coupling mechanism can be located on an underside of the cart. The second coupling mechanism can couple the cart to the floor plate of the receiving station. The second coupling mechanism can include a second set of sensors to interact with the first set of sensors to facilitate automatic execution of an operational mode of the robotic manipulator.

In some embodiments, the first set of sensors can include a first safety-rated proximity sensor. The second set of sensors can include a second safety-rated proximity sensor. The first safety-rated proximity sensor can be located on the underside of the cart, and the second safety-rated proximity sensor can be located on a topside of the floor plate. The first safety-rated proximity sensor can be arranged to engage with the second safety-rated proximity sensor located on the topside of the floor plate. Additionally, or alternatively, the first safety-rated proximity sensor can engage with the second safety-rated proximity sensor when the cart is successfully coupled with the floor plate, and the operational mode can be preventable when the first safety-rated proximity sensor is not engaged with the second safety-rated proximity sensor. Additionally, or alternatively, the first safety-rated proximity sensor can include a first housing and a first plurality of sections spaced apart within the first housing. The second safety-rated proximity sensor can include a second housing and a second plurality of sections spaced apart within the second housing. Each section of the first plurality of sections can interact with a corresponding section of the second plurality of sections, and the first safety-rated proximity sensor can be engaged with the second safety-rated proximity sensor when each section of the first plurality of sections interacts with each corresponding section of the second plurality of sections.

In some embodiments, the first set of sensors can include a first identification sensor. The first identification sensor can be located on the underside of the cart, and the second set of sensors can include a second identification sensor located on a topside of the floor plate. The first identification sensor can be arranged to engage with the second identification sensor located on the topside of the floor plate. Additionally, or alternatively, the first identification sensor can include a first RFID transmitter that can interact with the second identification sensor to receive information about the receiving station. The information can include a location of the receiving station within the operating environment, a type of operation performable at the location, and a list of available operational modes at the location. The first identification sensor can be communicatively coupled with a controller that can operate the robotic manipulator. The first identification sensor can transmit the information to the controller to facilitate a decision by the controller to automatically execute the operational mode, and the operational mode can be included in the list of available operational modes.

In some embodiments, the first set of sensors can include a plurality of safety-rated sensors and an identification sensor. A safety-rated proximity sensor of the plurality of safety-rated sensors and the identification sensor can be located spaced apart on the underside of the cart to engage with corresponding sensors located on the floor plate, and a safety-rated pressure sensor of the plurality of safety-rated sensors can be located within a slot of the second coupling mechanism to engage when a post from the floor plate protrudes into the slot to indicate when the cart is locked into the floor plate. Additionally, or alternatively, the device can include a plurality of casters and a plurality of wheels. Wheels of the plurality of wheels can be directionally fixed and positioned on an end of the cart to receive movement force, and casters of the plurality of casters can be directionally variable and positioned on an end of the cart opposite the end of the cart configured to receive the movement force. The cart can define a plurality of lifting slots, and each lifting slot of the plurality of lifting slots can be approximately parallel to other lifting slots of the plurality of lifting slots. Each lifting slot of the plurality of lifting slots can be formed on an underside of the cart, and the plurality of lifting slots can be positioned around and spaced apart from the second coupling mechanism.

In some embodiments, the first coupling mechanism can include a first restriction mechanism and a first latching mechanism. The second coupling mechanism can include a second restriction mechanism and a second latching mechanism. The first restriction mechanism and the second restriction mechanism can passively prevent lateral movement of the cart while the cart is coupled with the floor plate, and the first latching mechanism and the second latching mechanism can apply a coupling force to couple the cart with the floor plate. Additionally, or alternatively, the first restriction mechanism can include a plurality of slots on a topside of the floor plate. The second restriction mechanism can include a plurality of posts. Each post of the plurality of posts can extend below a bottom of the cart, and each post of the plurality of posts can be arranged to slide into a corresponding slot of the plurality of slots. Additionally, or alternatively, the first latching mechanism can include a protrusion that extends from the floor plate spaced apart from the plurality of slots. The second latching mechanism can include a clamp that extends below the bottom of the cart between the plurality of posts. The clamp can be arranged to engage with the protrusion and to apply the coupling force when engaged with the protrusion.

In some embodiments, a method can include decoupling a mobile robotic apparatus from a first receiving station of a plurality of receiving stations positioned on a floor of an operating environment. The mobile robotic apparatus can include a cart, a robotic manipulator, and a coupling mechanism. The cart can have a device for allowing the cart to be mobile. The robotic manipulator can be coupled with and can extend from the cart. The robotic manipulator can include an end effector for interacting with an item that can be positioned at a receiving station. The coupling mechanism can be located on the cart. The coupling mechanism can couple the cart to a floor plate of the receiving station located on a floor of an operating environment for facilitating operation of the robotic manipulator. The coupling mechanism can include a set of sensors to facilitate automatic execution of an operational mode of the robotic manipulator. The decoupling can include releasing the coupling mechanism from the first receiving station. The method can include moving the mobile robotic apparatus from the first receiving station of the plurality of receiving stations to a second receiving station of the plurality of receiving stations. The method can include coupling the mobile robotic apparatus with the second receiving station by engaging the coupling mechanism with the second receiving station. The method can include performing a robotic operation using the robotic manipulator in which the robotic operation is specific to a location associated with the second receiving station.

In some embodiments, a method can include determining that a mobile robotic apparatus is coupled with a first receiving station located at a first location of an operating environment. The mobile robotic apparatus can include a cart, a robotic manipulator, and a coupling mechanism. The cart can have a device for allowing the cart to be mobile. The robotic manipulator can be coupled with and can extend from the cart. The robotic manipulator can include an end effector for interacting with an item that can be positioned at a receiving station. The coupling mechanism can be located on the cart. The coupling mechanism can couple the cart to a floor plate of the receiving station located on a floor of an operating environment for facilitating operation of the robotic manipulator. The coupling mechanism can include a set of sensors to facilitate automatic execution of an operational mode of the robotic manipulator. The method can include determining that the first location is associated with a first operational mode of the robotic manipulator. The method can include executing the first operational mode of the robotic manipulator to cause the robotic manipulator to interact with an item in the operating environment.

In some embodiments, an apparatus can include a frame, a robotic manipulator, and a coupling device. The robotic manipulator can be coupled to and can extend from the frame. The robotic manipulator can include an end effector for interacting with an item that can be positioned adjacent to the frame. The coupling device can be positioned on the frame. The coupling device can be arranged to couple to a plurality of receiving stations located in an operating environment to facilitate operation of the robotic manipulator. The coupling device can include one or more first connector parts positioned on the frame to connect with one or more second connector parts positioned off of the frame to provide at least one of power or pneumatic pressure to the robotic manipulator.

In some embodiments, the one or more second connector parts can include a single connector body with an electrical connection and a pneumatic connection. The coupling device can include a pneumatic clamp to engage with a pneumatic clamping part, and the pneumatic clamping part can releasably couple and retain the frame in a fixed orientation with respect to each receiving station. Additionally, or alternatively, the one or more second connector parts can include one or more tool changers positioned on one or more machines in the operating environment, and the coupling device can be inserted into each tool changer of the one or more tool changers to couple the frame to a corresponding machine of the one or more machines. Additionally, or alternatively, the frame can have a bottom surface that is sized to receive a mobile, autonomous lifting device, and the coupling device can be coupled with the one or more second connector parts by the mobile, autonomous lifting device automatically positioning the coupling device into the one or more second connector parts.

In some embodiments, a system can include a mobile robotic apparatus and a mounting structure. The mobile robotic apparatus can include a frame and a robotic manipulator positioned on the frame. The mounting structure can be positioned on the frame. The mounting structure can include one or more first connector parts on the frame. The mounting structure can be mounted at a receiving station located in an operating environment. The receiving station can be sized to couple with the mounting structure to facilitate power and operation of the robotic manipulator and to orient the mobile robotic apparatus into a fixed orientation with respect to the receiving station.

In some embodiments, the receiving station can include a tool changer and an input port. The tool changer can receive the mounting structure, and the input port can include an electrical input, a pneumatic input, and a data input. Additionally, or alternatively, the tool changer can additionally include a receiving slot with a plurality of locking devices positioned around the receiving slot. The plurality of locking devices can correspond with a second plurality of locking devices on the mounting structure, and when the plurality of locking devices and the second plurality of locking devices engage with each other, the mobile robotic apparatus can be locked into place and aligned with the receiving station. The receiving station can be positioned on a floor of the operating environment. The receiving station can face in a direction opposite gravity, and an autonomous mobile robot can lift the mobile robotic apparatus to align the mounting structure with the receiving station and to lower the mobile robotic apparatus to connect the mounting structure to the receiving station. Additionally, or alternatively, the receiving station can be positioned on a machine located in the operating environment. The receiving station can face a direction orthogonal to gravity, and an autonomous mobile robot can translate the mobile robotic apparatus to align the mounting structure with the receiving station and to insert the mounting structure into the receiving station.

In some embodiments, a method can include decoupling a frame of a mobile robotic apparatus from a first receiving station of a plurality of receiving stations in an operating environment. The mobile robotic apparatus can include the frame, a robotic manipulator positioned on the frame, and a coupling device on the frame. The decoupling can include decoupling the coupling device from a corresponding connector at the first receiving station. The method can include moving, by an autonomous mobile robot, the mobile robotic apparatus from the first receiving station of the plurality of receiving stations to a second receiving station of the plurality of receiving stations. The method can include coupling, by the autonomous mobile robot, the mobile robotic apparatus to the second receiving station. The method can include performing a robotic operation using the robotic manipulator. The robotic operation can be specific to a location associated with the second receiving station.

### BRIEF DESCRIPTION OF DRAWINGS

The present disclosure is described in conjunction with the appended figures.

FIG. 1 illustrates a set of views of a mobile, dockable robotic apparatus that can be used to perform one or more robotic tasks according to some examples of the present disclosure.

FIG. 2 illustrates a perspective view of a mobile, dockable robotic apparatus being moved in which the mobile, dockable robotic apparatus can be used to perform one or more robotic tasks according to some examples of the present disclosure.

FIG. 3 illustrates a cart of a mobile, dockable robotic apparatus that can be used to perform one or more robotic tasks according to some examples of the present disclosure.

FIG. 4 illustrates a base of a cart of a mobile, dockable robotic apparatus that can be used to perform one or more robotic tasks according to some examples of the present disclosure.

FIG. 5 illustrates a front perspective view of a floor plate of a receiving station and illustrates a front perspective view of a coupling mechanism of a mobile, dockable robotic apparatus that can be used to perform one or more robotic tasks according to some examples of the present disclosure.

FIG. 6 illustrates a back perspective view of a floor plate of a receiving station and illustrates a back perspective view of a coupling mechanism of a mobile, dockable robotic apparatus that can be used to perform one or more robotic tasks according to some examples of the present disclosure.

FIG. 7 illustrates a back view of a floor plate of a receiving station coupled with a coupling mechanism of a mobile, dockable robotic apparatus that can be used to perform one or more robotic tasks according to some examples of the present disclosure.

FIG. 8 illustrates a top view of a floor plate of a receiving station according to some examples of the present disclosure.

FIG. 9 illustrates a flowchart of a process for executing a particular operational mode of a robotic manipulator based on a detected location of a mobile, dockable robotic apparatus according to some examples of the present disclosure.

FIG. 10 illustrates a perspective view of a mobile, dockable robotic apparatus being moved with an autonomous robot in which the mobile, dockable robotic apparatus can be automatically connected to a receiving station to perform one or more robotic tasks according to some examples of the present disclosure.

FIG. 11 illustrates a detailed view of a connection between a mobile, dockable robotic apparatus and a receiving station to facilitate one or more robotic tasks according to some examples of the present disclosure.

FIGS. 12A-12B illustrate perspective views of a receiving station that can receive a mobile, dockable robotic apparatus to facilitate one or more robotic tasks according to some examples of the present disclosure.

FIG. 13 illustrates a flowchart of a process for executing a particular operational mode of a robotic manipulator based on a location that a mobile, dockable robotic apparatus was moved to by an autonomous robot according to some examples of the present disclosure.

FIG. 14 is a block diagram of an example of a computer system that can be associated with a mobile, dockable robotic apparatus according to some examples of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Certain aspects and features of the present disclosure relate to a mobile, dockable robotic apparatus that can be used to perform one or more robotic operations. The mobile, dockable robotic apparatus can be mobile, such as positioned on wheels, casters, tracks, or other suitable conveyance means, and the mobile, dockable robotic apparatus can be collaborative such as used by an operator or by another robotic entity to perform the one or more robotic operations. The mobile, dockable robotic apparatus can be dockable via a clamping mechanism that can be positioned on a cart of the mobile, dockable robotic apparatus. For example, the clamping mechanism can be positioned on a bottom surface of the cart, and the clamping mechanism can be arranged to engage or otherwise interlock with a receiving station on a floor of a production area. The receiving station may receive the clamping mechanism, and the clamping mechanism and/or the receiving station may lock the mobile, dockable robotic apparatus in place to perform a robotic operation.

In some embodiments, a location of the mobile, dockable robotic apparatus can be detected, such as by using one or more sensors, from input by an operator, etc., and the location can be used to control an operational mode, or the one or more robotic operations, associated with a robotic manipulator included in the mobile, dockable robotic apparatus. For example, a controller, or a computing device associated with the mobile, dockable robotic apparatus, can determine that the mobile, dockable robotic apparatus is docked at a first receiving station, and the controller, or the computing device associated with the mobile, dockable robotic apparatus, can select an appropriate operational mode in which the robotic manipulator can operate based on the location. In some embodiments, selecting the operating mode can be performed without requiring any calibration of the robotic manipulator at the first location. The mobile, dockable robotic apparatus can be decoupled, such as by operating the clamping mechanism, from the first receiving station, and the mobile, dockable robotic apparatus can be moved to a second receiving station. The controller, or the computing device, associated with the mobile, dockable robotic apparatus can repeat the above steps to determine in which operational mode to operate the robotic manipulator and/or to select an appropriate set of operations for the robotic manipulator to perform based at least in part on the location of the mobile, dockable robotic apparatus.

In some embodiments, the operational mode can be automatically selected and/or enabled based on one or more sensors associated with the mobile, dockable robotic apparatus. The one or more sensors can include one or more proximity sensors, one or more safety sensors, or other suitable sensors that can be used to automatically select and/or enable the operational mode. In a particular example, the cart of the mobile, dockable robotic apparatus can include a set of safety sensors on an underside of the cart that can be arranged to approximately line up with a corresponding set of safety sensors positioned within a floor plate of a receiving station. When the set of safety sensors are engaged with the corresponding set of safety sensors, the controller, or the computing device, associated with the mobile, dockable robotic apparatus can receive a signal that enables selection and running of operational modes of the robotic manipulator. If the set of safety sensors are not engaged with the corresponding set of safety sensors, the controller, or the computing device, associated with the mobile, dockable robotic apparatus may be prevented from loading and/or executing any operational modes such as to preserve safety in an operating environment.

Additionally, or alternatively, the mobile, dockable robotic apparatus may include a proximity sensor, or other suitable sensor, that can be used to identify the receiving station at which the mobile, dockable robotic apparatus is docked. The floor plate may have a corresponding proximity sensor that can cause the proximity sensor, when engaged with the corresponding proximity sensor, to transmit data to the controller, or the computing device, to indicate which receiving station the mobile, dockable robotic apparatus is located, to indicate which operational modes are available to be performed at the identified receiving station, etc. Upon the controller, or the computing device, receiving signals from the set of safety sensors and the proximity sensor indicating that the mobile, dockable robotic apparatus is safely docked and indicating the available operational modes, respectively, the controller, or the computing device, may automatically select the operational mode, may automatically execute a previously selected operational mode, or some combination thereof.

In some embodiments, the mobile, dockable robotic apparatus, or the robotic manipulator thereof, can be calibrated when the mobile, dockable robotic apparatus is first deployed at a first location such as a first receiving station. The same calibration process can be performed when the mobile, dockable robotic apparatus is deployed at a second location, at a third location, and so on. Upon the mobile, dockable robotic apparatus being deployed at the first location at a later time, or otherwise for a second time after the initial time, calibration may be skipped or briefly confirmed. The robotic manipulator can begin working as soon as the mobile, dockable robotic apparatus is docked. The same can apply for the second location, the third location, and so on. Work efficiency of the mobile, dockable robotic apparatus is significantly increased over other robotic apparatuses using this approach.

The mobile, dockable robotic apparatus may include a coupling assembly that can allow the mobile, dockable robotic apparatus to interface with, and couple to, a floor plate or other coupling mechanism attached to a floor of an operating environment. The coupling assembly may include the sensors described above such as the set of safety sensors, the proximity sensor, and/or other sensors that can support operation and/or docking within the operating environment. The coupling assembly, the floor plate, or a combination thereof, may include one or more keyed surfaces that can provide additional safety such as by preventing the mobile, dockable robotic apparatus from being lifted off of the floor in cases in which coupling with the floor plate fails. In some embodiments, the coupling assembly can be positioned on an underside of the cart of the mobile, dockable robotic apparatus, though the coupling assembly may be positioned in other locations on the cart. Additionally, or alternatively, the coupling assembly may be positioned approximately, such as within a tolerance of 20% with respect to a precise location, along one or more central axes of the mobile, dockable robotic apparatus. In other examples, the coupling assembly may be located off-center of one or more of the central axes defined by the mobile, dockable robotic apparatus.

The floor plate may be secured to the floor of the operating environment. For example, the floor plate can be welded to the floor, can be built-in to the floor, can be secured to the floor with bolts, rivets, screws, or the like, etc. The floor plate may define a shape that allows the mobile, dockable robotic apparatus to easily couple with the floor plate. For example, a portion of the floor plate may be tapered, sloped, or beveled to allow a larger tolerance for initial insertion of the cart over the floor plate with a higher chance of successful coupling than other floor plates without the taper, slope, or bevel. Additionally, or alternatively, the floor plate may include rounded edges to further increase the chances of initial successful coupling. Additionally, or alternatively, the floor plate may include a keyed coupling mechanism that can prevent the mobile, dockable robotic apparatus from being lifted off of the floor if the initial coupling fails. Additionally, or alternatively, the floor plate may include a bracket that can be inserted into a corresponding slot in the mobile, dockable robotic apparatus. By inserting the bracket into the corresponding slot, another safety sensor may be engaged to indicate that the coupling has been successful.

Various different safety sensors, proximity sensors, docking sensors, and/or other sensors may be included in the mobile, dockable robotic apparatus, the floor plate, or a combination thereof. For example, the safety sensors can include RFID sensors, capacitive sensors, magnetic sensors, and so on. In a particular example, the safety sensors can include capacitive sensors that can have a small location tolerance for ensuring that the mobile, dockable robotic apparatus is successfully docked, the docking sensors can include RFID sensors that are programmed with a particular location and available operational programs, etc.

In some examples, a system may include the mobile, dockable robotic apparatus, which can include a robotic manipulator on a cart, and an autonomous mobile robot (AMR). The mobile, dockable apparatus may include a frame, the robotic apparatus mounted thereto, a connector body for connecting various systems of the robotic apparatus to offboard systems, and/or one or more clamping parts. The frame, or the cart, may include a rigid frame to support the robotic apparatus. The robotic apparatus and the frame, or the cart, may be similar or identical to those described above or may include modifications to allow the mobile, dockable robotic apparatus to be moved by the AMR between different receiving stations. The AMR may be programmed, or otherwise interact with a local or global coordination system, to pick up and move the mobile, dockable robotic apparatus between and among different stations.

The connector body may be configured to support multiple types of connections between the robotic apparatus and offboard systems. Some examples of the multiple types of connections can include an electrical connection for powering the robotic apparatus, a pneumatic connection for doing the same, etc. In some examples, one connector part can be mounted to the frame, and a corresponding connector part can be mounted at the receiving station. For example, the connector body may arrange multiple types of connections in one body.

The one or more clamping parts may include any suitable structure for mating with or otherwise rigidly and releasably coupling the frame at the receiving station. In some examples, a clamping system, which may include a set of clamping parts with one mounted to the frame and a corresponding part mounted at the receiving station, may be pneumatically controlled. For example, one or more rigid pins may be mounted to the frame, and one or more cylindrical pneumatic couplings may be mounted at the receiving station. An example may include a pneumatic pull clamp configured to clamp workpieces to fixtures. Application of compressed air at a first inlet of the clamp may open the clamp, while applying compressed air at a second inlet of the clamp may close the clamp. In some examples, the clamping parts may be pneumatic clamps that, when driven, can cause an arcuate ramp section to engage with a corresponding structure to retain and align parts.

In operation, the connector parts and the clamping parts may be coupled as part of the AMR docking the frame or the cart at the receiving station. The parts may be aligned in a Z-orientation or a Y-orientation. In the Z-orientation, the frame may be brought into a vertical position above the connecting parts at the receiving station, then lowered down such that the connections are made and the frame or the cart can be set down at the station such as resting in a rigid manner). In a Y-orientation, the frame may be driven horizontally towards the connecting parts that can be oriented horizontally. The AMR may stop when the connections are made. In some examples, mechanical guides may be used to direct and/or otherwise align the frame or the cart with the receiving station and connectors. In some examples, one or more sensors may be disposed around the frame or the cart to indicate a position of the frame or the cart with respect to the receiving station. In some examples, the frame or the cart may be set in a fixed location, and the connections may be established using actuators that can drive the connecting parts. In this manner, the placement of the frame or the cart may be require less precision than compared to an embodiment in which the AMR places the frame and makes the connections simultaneously.

In some embodiments, the coupling mechanism can include one or more rods, one or more slots, a clamping mechanism, and/or any additional features that can provide mechanical repeatability. The mechanical repeatability can involve the ability to position the mobile, dockable robotic apparatus at a predetermined location (e.g., at a receiving station) to within a threshold distance every time. In some embodiments, the threshold distance can be 0.005 inches (0.0127 cm). For example, each time the mobile, dockable robotic apparatus is coupled with a floor plate of the receiving station, the mobile, dockable robotic apparatus can be within 0.005 inches (0.0127 cm) of the same location associated with the receiving station. By providing the mechanical repeatability, calibration can be performed one time (e.g., the first time the mobile, dockable robotic apparatus is positioned at the receiving station) and can be skipped each subsequent time. Additionally, or alternatively, the rods may be replaced with tapered registration members, conical centering pins, precision locating mandrels, or the like that can engage with matching hardened receivers. The geometry of components of the coupling mechanism can force the cart into a precise coordinate origin as a latching force is applied.

In some embodiments, the one or more rods, the one or more slots, the clamping mechanism, and/or any additional features that can provide mechanical repeatability can provide constraints in six degrees of freedom. For example, motion in an X-direction, a Y-direction, a Z-direction, a pitch direction, a roll direction, and a yaw directions can be restricted. The rods may have an enlarged outer diameter at an end that is to be positioned in the slots, and the clamping mechanism can pull-tight the cart of the mobile, dockable robotic apparatus to the floor plate to ensure that motion in the six degrees of freedom are limited or otherwise restricted.

In some embodiments, the floor plate can be or include a repeatable mechanical datum. Docking the mobile, dockable robotic apparatus at the floor plate can include mechanically synchronizing a coordinate system of the robotic manipulator with a workstation (e.g., at the receiving station). This mechanical synchronization can provide zero-point confidence for immediate operations without manual retraining. Additionally, or alternatively, the mechanical certainty provided by the mechanical synchronization can allow execution of identified operational modes of the robotic manipulator to be performed automatically such as without manual input, calibration, etc.

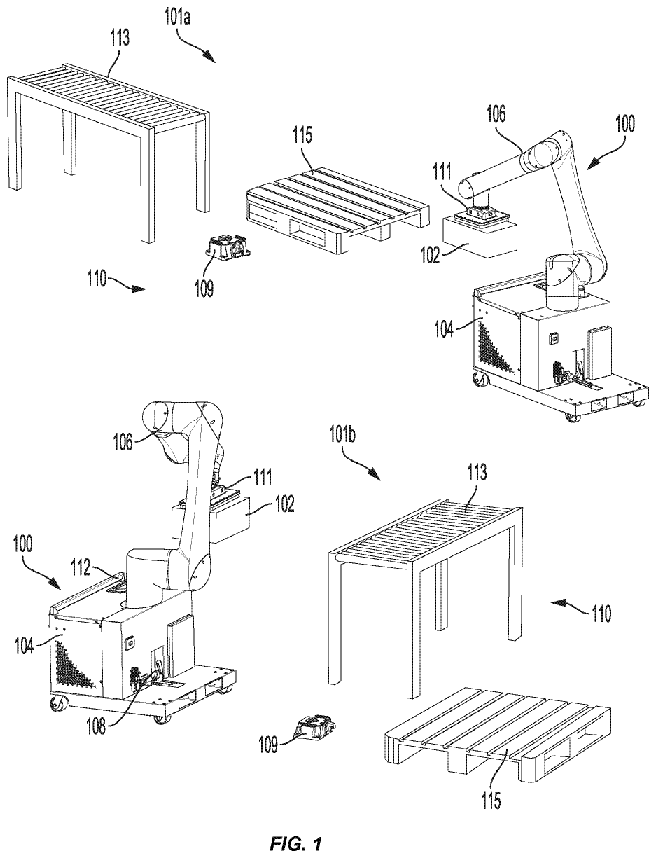

Turning now to the Figures, FIG. 1 illustrates a mobile, dockable robotic apparatus 100 that can be used to perform one or more robotic tasks according to some examples of the present disclosure. FIG. 1 illustrates different perspective views 101a-b of the mobile, dockable robotic apparatus 100, and FIG. 1 illustrates the mobile, dockable robotic apparatus 100 interacting with an item 102, which may be located at, or planned to be taken to, a receiving station 110. The receiving station can include a floor plate 109, a conveyor 113, a pallet 115, and/or any other suitable component or device. As illustrated in FIG. 1, the item 102 is a package, but in other examples, the item 102 can include other suitable items, such as a pallet, a box, etc., that can be interacted with using the mobile, dockable robotic apparatus 100.

The mobile, dockable robotic apparatus 100 can include a cart 104, a robotic manipulator 106, and a coupling mechanism 108. In some examples, the robotic manipulator 106 can include a collaborative robotic manipulator or any other suitable robotic manipulator. Additionally, or alternatively, the robotic manipulator 106 can include an end effector 111 that can interact with the item 102. The end effector 111 may be vacuum-power, can be or include a gripper or gripping mechanism, may be retractable, etc. The coupling mechanism 108 may couple the mobile, dockable robotic apparatus 100 with the floor plate 109 of the receiving station 110 secured to a floor of an operating environment such as a production area. A controller 112, or other suitable computing device, can select or otherwise automatically control operations performed by the robotic manipulator 106.

In some embodiments, the mobile, dockable robotic apparatus 100 can be moved between receiving stations and can be docked at different floor plates of the receiving stations. The floor plates, such as the floor plate 109, can secure and immobilize the mobile, dockable robotic apparatus 100 to allow the robotic manipulator 106 to perform operations involving the item 102 or other suitable devices or components at the respective receiving station. The operations may be specific to the respective receiving station. For example, the floor plate 109 may have one or more sensors that may indicate, such as to the controller 112, available operations to perform at a location associated with the respective receiving station such as after verifying that the mobile, dockable robotic apparatus 100 is properly secured at the respective receiving station. In a particular example, a single collaborative robot can be used and moved between receiving stations since having one or more robots for each receiving station might not be cost effective, may take up too much room, may provide inefficient or dangerous output, etc.

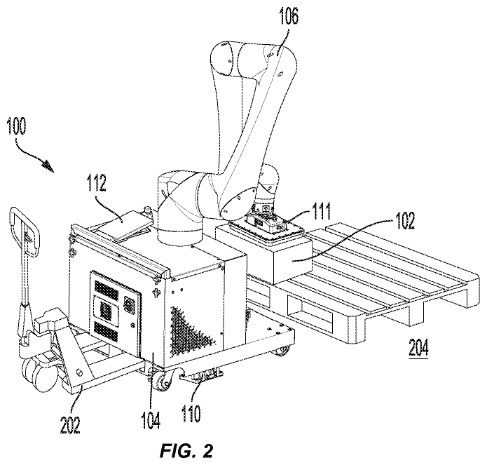

FIG. 2 illustrates a perspective view of a mobile, dockable robotic apparatus 100 being moved in which the mobile, dockable robotic apparatus 100 can be used to perform one or more robotic tasks according to some examples of the present disclosure. As illustrated in FIG. 2, the mobile, dockable robotic apparatus 100 can include the cart 104, which may include or be replaced with a frame, can include the robotic manipulator 106, which can include the end effector 111, can include the coupling mechanism 108, and can include the controller 112. The mobile, dockable robotic apparatus 100 may be moved using a moving device 202. The moving device 202 may include a manual pallet jack or forklift, may include an autonomous robot with lifting capabilities, or may include other suitable device that can move the mobile, dockable robotic apparatus 100. The moving device 202 may lift, translate, or otherwise move the mobile, dockable robotic apparatus 100 to cause the mobile, dockable robotic apparatus 100 to engage with the receiving station 110. As illustrated in FIG. 2, the receiving station 110 can be installed on a floor 204 of the operating environment, but, in other examples, the receiving station 110 can be otherwise located such as on a machine of the operating environment, etc.

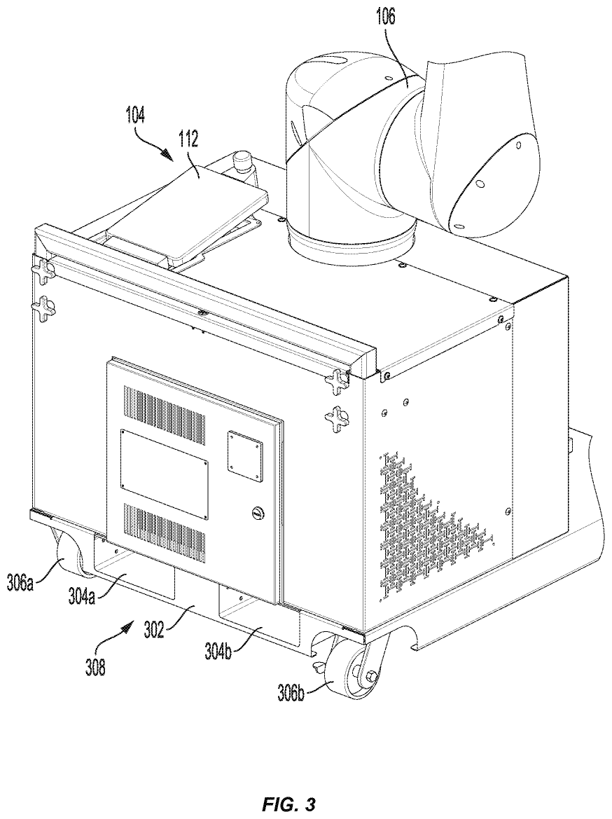

FIG. 3 illustrates a cart 104 of a mobile, dockable robotic apparatus 100 that can be used to perform one or more robotic tasks according to some examples of the present disclosure. As illustrated in FIG. 3, the cart 104 can have the robotic manipulator 106 extending from the cart 104. Additionally, or alternatively, the cart 104 may be located on or otherwise include a base 302 that can define multiple lifting slots such as a first lifting slot 304a and a second lifting slot 304b. Each lifting slot of the lifting slots can be approximately parallel to other lifting slots, and each lifting slot can be formed on an underside of the cart 104 . The lifting slots can be positioned around and spaced apart from the coupling mechanism 108 of the mobile, dockable robotic apparatus 100.

In some embodiments, the cart 104 can have a device that can allow the mobile, dockable robotic apparatus to be mobile. As illustrated in FIG. 3, the device can include a set of casters such as a first caster 306a and a second caster 306b. The set of casters may be located on a rear side 308 of the cart 104 such as to allow greater control of movement for the mobile, dockable robotic apparatus 100. In some embodiments, the device may additionally include fixed wheels on a side opposite the rear side 308.

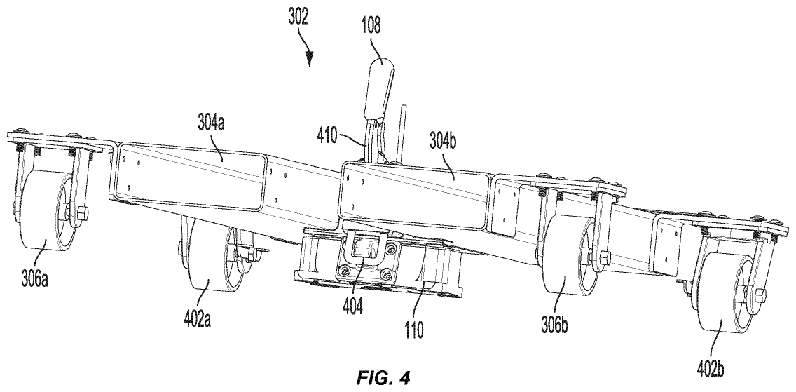

FIG. 4 illustrates a base 302 of a cart 104 of a mobile, dockable robotic apparatus 100 that can be used to perform one or more robotic tasks according to some examples of the present disclosure. As illustrated in FIG. 4, the base 302 can include the first lifting slot 304a, the second lifting slot 304b, the set of casters, and a set of fixed wheels. Certain features, such as the cart 104, the robotic manipulator 106, and others, are not shown in FIG. 4 or have been removed to highlight the illustrated features. The set of casters can include the first caster 306a and the second caster 306b, and the set of fixed wheels can include a first fixed wheel 402a and a second fixed wheel 402b. Other arrangements of casters and wheels are possible for the base 302.

In some embodiments, the coupling mechanism 108 can be positioned on the base 302 and may extend downward to allow a coupling between the mobile, dockable robotic apparatus 100 and the receiving station 110. The coupling mechanism 108 can include a clamp 410, one or more coupling projections, such as rods or shafts, etc. The coupling mechanism 108 may be centered within the base 302, though the coupling mechanism 108 may be positioned in other locations on the base 302, or the coupling mechanism 108 may include more than one connection point.

As illustrated in FIG. 4, the coupling mechanism 108 can be connected to the receiving station 110 at connection point 404, though other or additional locations are possible. In some examples, the coupling between the receiving station 110 and the coupling mechanism 108 can be manual or automatic. A pneumatic mechanism, a hydraulic mechanism, an electric mechanism or actuator, or other suitable automatic mechanism can be used to enable the coupling between the receiving station 110 and the coupling mechanism 108. The coupling can be powered by onboard power of the robotic manipulator 106, such as an onboard air tank, etc., since the robotic manipulator 106 may not be plugged in before the coupling occurs. Additionally, or alternatively, the coupling mechanism 108 can be moved into place, such as close to the final position, at the receiving station 110 and can be plugged in then coupled using the power from the receiving station 110 rather than, or in addition to, the onboard power.

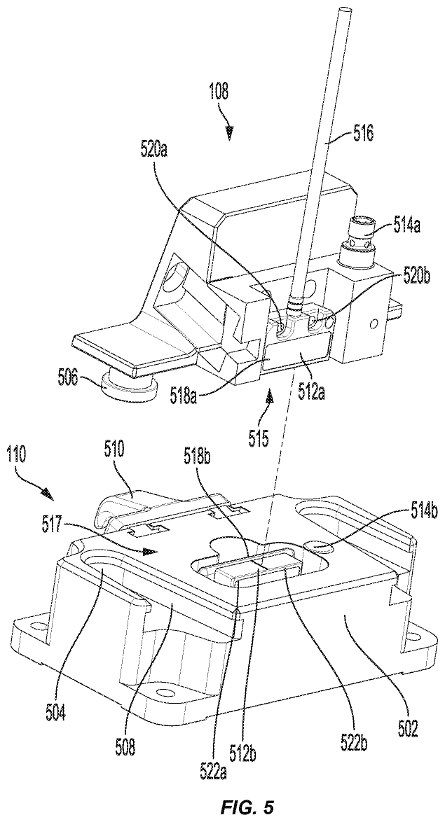

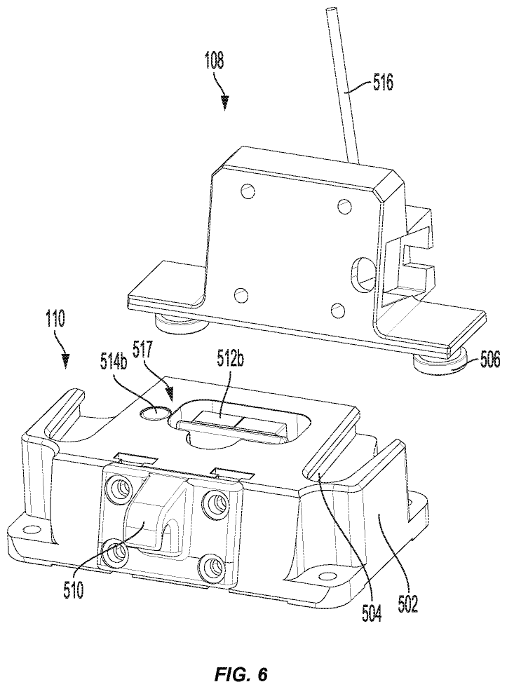

FIG. 5 illustrates a front perspective view of a floor plate 502 of a receiving station 110 and illustrates a front perspective view of a coupling mechanism 108 of a mobile, dockable robotic apparatus 100 that can be used to perform one or more robotic tasks according to some examples of the present disclosure. Additionally, FIG. 6 illustrates a back perspective view of the floor plate 502 of the receiving station 110 and illustrates a back perspective view of the coupling mechanism 108 of the mobile, dockable robotic apparatus 100 that can be used to perform one or more robotic tasks according to some examples of the present disclosure. The floor plate 502 may define one or more connection points with which the coupling mechanism 108 can engage to couple the mobile, dockable robotic apparatus 100 to the receiving station 110. For example, the floor plate 502 can include a connection point 504 that can be sized to receive a coupling projection 506 on the coupling mechanism 108. Multiple connection points can be used. In some examples, multiple plates on the floor plate 502 can be used, the connection points, or receiving slots in the floor plate 502, can have different numbers or orientations compared with those illustrated in the FIGS. A wall 508 may be tapered to guide the coupling projection 506 into the connection point 504. Additionally, or alternatively, the floor plate 502 may have a protrusion 510, such as a hook, that can be used as a secondary or redundant connection point to receive a clamp from the mobile, dockable robotic apparatus 100.

The coupling mechanism 108 can include a first set of sensors, and the receiving station 110, or the floor plate 502 thereof, can include a second set of sensors. The first set of sensors can include a first proximity sensor 512a and a first identification sensor 514a, and the second set of sensors can include a second proximity sensor 512b and a second identification sensor 514b. The first proximity sensor 512a and the second proximity sensor 512b may each be a safety-rated proximity sensor. The first proximity sensor 512a can be located on an underside 515 of the cart 104, the second proximity sensor 512b can be located on a topside 517 of the floor plate 502. In some embodiments, the first proximity sensor 512a can be arranged to engage with the second proximity sensor 512b. In some embodiments, the first proximity sensor 512a can engage with the second proximity sensor 512b when the cart 104 is successfully coupled with the floor plate 502,

In some embodiments, the first proximity sensor 512a can include a first housing 518a and a first set of sections spaced apart within the first housing 518a. The first set of sections can include a first section 520a and a second section 520b, though other suitable numbers of sections are possible to include in the first set of sections. The second proximity sensor 512b can include a second housing 518b and a second set of sections spaced apart within the second housing 518b. The second set of sections can include a first section 522a and a second section 522b. Each section of the first set of sections can interact with a corresponding section of the second set of sections. The first proximity sensor 512a can be engaged with the second proximity sensor 512b when each section of the first set of sections interacts with each corresponding section of the second set of sections.

In some embodiments, the first set of sensors can include a first identification sensor 514a. The first identification sensor 514a can be located on an underside 515 of the cart 104. The second set of sensors can include a second identification sensor 514b that can be located on a topside 517 of the floor plate 502. The first identification sensor 514a can be arranged to engage with the second identification sensor 514b. In some embodiments, the first identification sensor 514a can include a first RFID transmitter that can interact with the second identification sensor 514b to receive information about the receiving station 110. The information can include a location of the receiving station 110 within the operating environment, a type of operation performable at the location, and a list of available operational modes at the location. The first identification sensor 514a can be communicatively coupled with the controller 112 that can operate the robotic manipulator 106. The first identification sensor 514a can transmit, such as via antenna 516, the information to the controller 112 to facilitate a decision by the controller 112 to automatically execute an operational mode of the robotic manipulator 106.

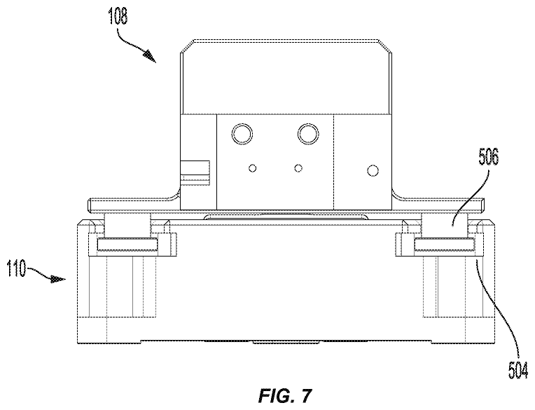

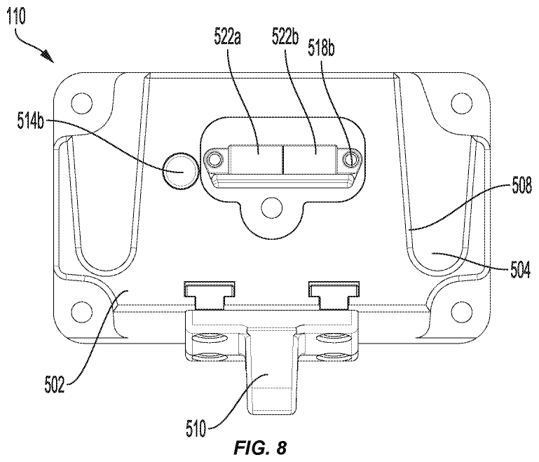

FIG. 7 illustrates a back view of a floor plate 502 of a receiving station 110 coupled with coupling mechanism 108 of a mobile, dockable robotic apparatus 100 that can be used to perform one or more robotic tasks according to some examples of the present disclosure. Additionally, FIG. 8 illustrates a top view of the floor plate 502 of the receiving station 110 according to some examples of the present disclosure. As illustrated in FIGS. 7-8, the coupling mechanism 108 can include the coupling projection 506, which can be or include a rod, a shaft, or the like. The floor plate 502 can include the connection point 504, which can be or include a slot or other receiving component that can receive the coupling projection 506. The coupling mechanism 108 and the floor plate 502 may have multiple projections and/or points to enhance the coupling between the mobile, dockable robotic apparatus 100 and the receiving station 110.

In some embodiments, the coupling projection 506 can have a small outer diameter along a shaft and can have a large outer diameter at an end that is configured to be positioned in the connection point 504 or slot thereof. The large outer diameter causes the mobile, dockable robotic apparatus 100 to resist tipping over during operation while coupled with the receiving station 110 or the floor plate 502 thereof. That is, the large outer diameter can resist vertical forces and rotational moments to reliably keep the mobile, dockable robotic apparatus 100 firmly on the floor during operation of the robotic manipulator 106 and while the mobile, dockable robotic apparatus 100 is coupled with the floor plate 502 (e.g., while the coupling projection 506 is positioned in the connection point 504).

In some embodiments, the floor plate 502 may include the protrusion 510 that can receive the clamp 410 from the coupling mechanism 108. The protrusion 510 may be sized and shaped so that, when the clamp 410 engages with the protrusion 510, the clamp 410 can apply a coupling force that can physically retain the mobile, dockable robotic apparatus 100 in a predefined location with respect to the receiving station 110. Additionally, or alternatively, the projections, such as the coupling projection 506, can be positioned in the connection points, such as connection point 504, to restrict movement, such as lateral movement, to allow the clamp 410 to engage with the protrusion 510 to apply the coupling force. The projections may be guided into the connection points via walls such as the wall 508, which can maximize a success chance for initially coupling the mobile, dockable robotic apparatus 100 with the receiving station 110.

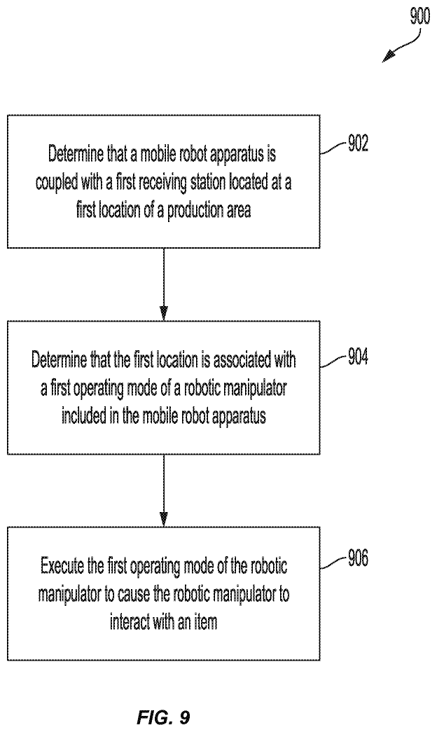

FIG. 9 is a flowchart of a process 900 for selecting and executing a particular operational mode for the robotic manipulator 106 based on a location of the mobile, dockable robotic apparatus 100. An item 102, such as a box, a pallet, a package, or other suitable item, may be manipulated via the robotic manipulator 106 of the mobile, dockable robotic apparatus 100, and the robotic manipulator 106 can at least temporarily pick up and manipulate the item 102 using an end effector of the robotic manipulator 106. In some embodiments, the process 900 may be or otherwise include a computer-implemented process that includes a set of instructions, which may be stored in a non-transitory computer-readable media (e.g., via the controller 112), for controlling the robotic manipulator 106 to manipulate the item 102 to perform operations associated with a particular operational mode. In some embodiments, zero or more operations of the process 900 may be performed, at least in part, by a human operator. Additionally, while the process 900 is described with respect to the mobile, dockable robotic apparatus 100, other suitable apparatuses can additionally or alternatively be used with respect to the process 900.

The process 900 may begin at block 902 by determining that a mobile, dockable robotic apparatus 100 is coupled with a first receiving station located at a first location of an operating environment. Sensors of the mobile, dockable robotic apparatus 100 can be engaged with corresponding sensors of the first receiving station, and a controller of the mobile, dockable robotic apparatus 100 can determine, based on the engagement, at which receiving station the mobile, dockable robotic apparatus 100 is located. The controller may determine the first location.

The process 900 may continue at block 904 by determining that the first location is associated with a first operational mode of a robotic manipulator 106 included in the mobile, dockable robotic apparatus 100. The first operational mode may be associated only with the first location, or the first operational mode may be associated with the first location and one or more other locations. Determining that the first location is associated with the first operational mode may additionally involve determining whether the mobile, dockable robotic apparatus 100 is properly or successfully docked at the first receiving station.

The process 900 may continue at block 906 by executing the first operational mode of the robotic manipulator 106 to cause the robotic manipulator 106 to interact with the item 102. Prior to executing the first operational mode, the controller may verify that the mobile, dockable robotic apparatus 100 is properly or successfully docked at the first receiving station. If the mobile, dockable robotic apparatus 100 is not properly or successfully docked at the first receiving station, the first operational mode, along with any other operational mode, may be prevented from being executed. If the mobile, dockable robotic apparatus 100 is properly or successfully docked at the first receiving station, the controller may execute the first operational mode.

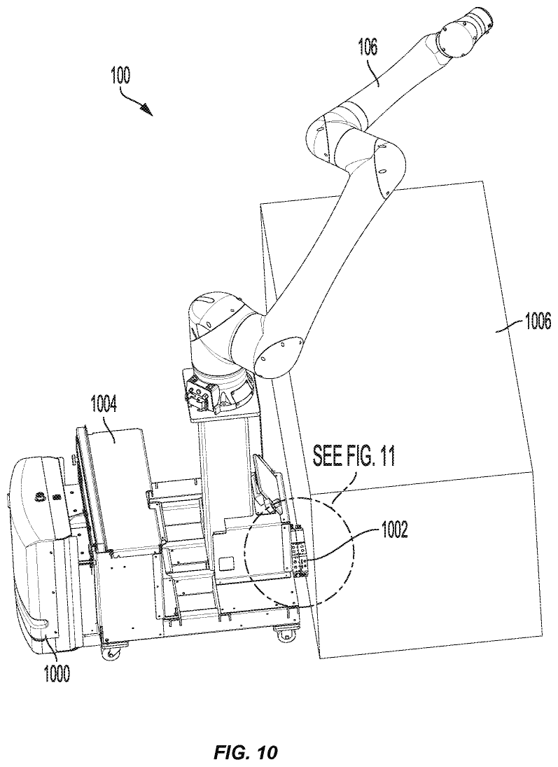

FIG. 10 illustrates a perspective view of a mobile, dockable robotic apparatus 100 being moved with an autonomous robot 1000 in which the mobile, dockable robotic apparatus 100 can be automatically connected to a receiving station 1002 to perform one or more robotic tasks according to some examples of the present disclosure. As illustrated in FIG. 10, the mobile, dockable robotic apparatus 100 can include a frame 1004 and a robotic manipulator 106. The frame 1004 may be similar to the cart 104 but may be configured to be moved with the autonomous robot 1000. The autonomous robot 1000 can lift the frame 1004 to move the mobile, dockable robotic apparatus 100, can engage with the frame 1004 to translate the mobile, dockable robotic apparatus 100, or may otherwise engage with the frame 1004 to move the mobile, dockable robotic apparatus 100.

The mobile, dockable robotic apparatus 100 can engage with the receiving station 1002 to allow the robotic manipulator 106 to perform one or more robotic operations such as manipulating an item. The receiving station 1002 may be located on a floor of an operating environment, may be located on a machine 1006 of the operating environment, or in other suitable locations. The receiving station 1002 may face a direction opposite gravity, may face a direction orthogonal to gravity (e.g., such as illustrated in FIG. 10), or may face in other suitable directions.

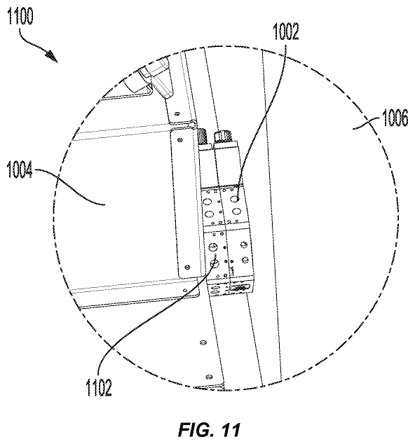

FIG. 11 illustrates a detailed view of a connection between a mobile, dockable robotic apparatus 100 and a receiving station 1002 to facilitate one or more robotic tasks according to some examples of the present disclosure. As illustrated in FIG. 11, the mobile, dockable robotic apparatus 100 can include a mounting structure 1102 that can oppose the receiving station 1002. In some embodiments, the mounting structure 1102 can be or include one or more first connector parts, and the receiving station 1002 can be or include one or more second connector parts that can oppose, complement, or otherwise correspond with the one or more first connector parts. As illustrated in FIG. 11, the receiving station 1002 is secured to a wall of the machine 1006, but in other examples, the receiving station 1002 can be secured to a floor of the operating environment, or to a different surface in the operating environment. For example, while the receiving station 1002 is illustrated as facing a direction orthogonal to gravity, the receiving station may face a different direction such as a direction facing opposite gravity, or a direction that is neither parallel, orthogonal, nor opposing gravity.

In some embodiments, the receiving station 1002 may orient the mobile, dockable robotic apparatus 100, may immobilize the mobile, dockable robotic apparatus 100, etc. The receiving station 1002 may face in a particular direction at a particular location to cause the robotic manipulator 106 to be in a proper or correct location for performing a particular operation specific to the location of the receiving station 1002 when the mounting structure 1102 of the mobile, dockable robotic apparatus 100 is docked at the receiving station 1002. Additionally, or alternatively, the receiving station 1002 may lock the mobile, dockable robotic apparatus 100 in place such as by a locking mechanism that engages with a corresponding mechanism in the mounting structure 1102.

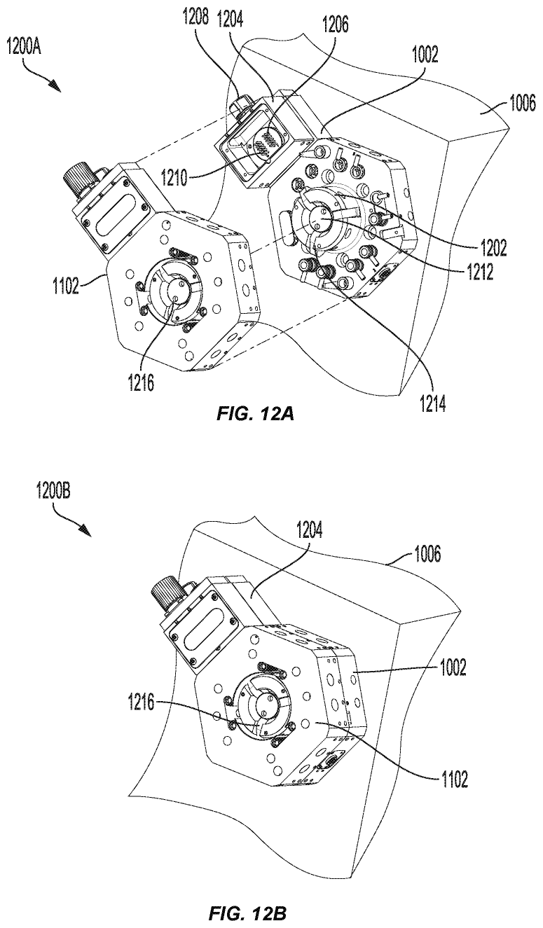

FIGS. 12A-12B illustrate perspective views 1200A-B of a receiving station 1002 that can receive a mobile, dockable robotic apparatus 100 to facilitate one or more robotic tasks according to some examples of the present disclosure. The perspective view 1200A illustrates the mounting structure 1102 and the receiving station 1002 spaced apart from one another and not engaged, and the perspective view 1200B illustrates the mounting structure 1102 engaged with the receiving station 1002.

As illustrated in FIGS. 12A-B, the receiving station 1002 can include a tool changer 1202 and an input port 1204. The tool changer 1202 may be sized to receive a corresponding component of the mounting structure 1102. The input port 1204 can include an electrical input 1206, a pneumatic input 1208, a data input 1210, other suitable types of inputs, or any combination thereof. In some embodiments, the input port 1204 can provide electrical power, pneumatic power, and data communication capabilities for the robotic manipulator 106 and/or the controller 112 to allow robotic operations to be autonomously performed.

In some embodiments, the tool changer 1202 can include a receiving slot 1212 that can include multiple locking devices such as locking device 1214. The multiple locking devices can be positioned around the receiving slot 1212, and the multiple locking devices can correspond to second multiple locking devices, such as locking device 1216, of the mounting structure 1102. Once the multiple locking devices and the second multiple locking devices engage with each other (e.g., as in the perspective view 1200B), the mobile, dockable robotic apparatus 100 can be locked into place and aligned with the receiving station 1002.

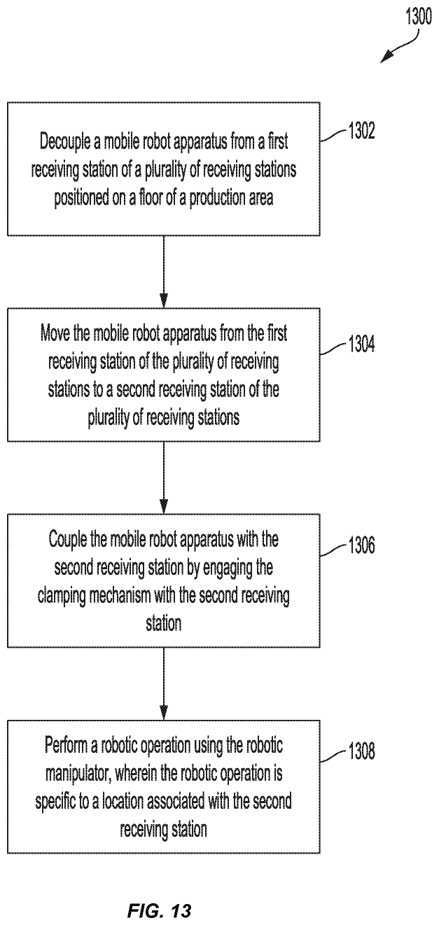

FIG. 13 is a flowchart of a process 1300 for coupling and/or decoupling the mobile, dockable robotic apparatus 100 for performing different operations based on a location of the mobile, dockable robotic apparatus 100. An item 102, such as a box, a pallet, a package, or other suitable item, may be manipulated via a robotic manipulator 106 of the mobile, dockable robotic apparatus 100, and the robotic manipulator 106 can at least temporarily pick up and manipulate the item 102 using an end effector of the robotic manipulator 106. In some embodiments, the process 1300 may be or otherwise include a computer-implemented process that includes a set of instructions, which may be stored in a non-transitory computer-readable media, for controlling the robotic manipulator 106 to manipulate the item 102 to perform operations associated with a particular operational mode or for controlling a location of the mobile, dockable robotic apparatus 100. In some embodiments, zero or more operations of the process 1300 may be performed, at least in part, by a human operator. Additionally, while the process 1300 is described with respect to the mobile, dockable robotic apparatus 100, other suitable apparatuses can additionally or alternatively be used with respect to the process 1300.

The process 1300 may begin at block 1302 by decoupling a mobile, dockable robotic apparatus 100 from a first receiving station of a set of receiving stations positioned in an operating environment. The mobile, dockable robotic apparatus 100 can include a frame 1004, the robotic manipulator 106 positioned on the frame 1004, and a mounting structure positioned on the frame 1004. The decoupling can include automatically releasing the mounting structure from the first receiving station. The mounting structure, and/or the receiving station 1002, may have a pneumatic system that can automatically release the mounting structure from the receiving station 1002 when instructions from the controller are provided.

The process 1300 may continue at block 1304 by moving the mobile, dockable robotic apparatus 100 from the first receiving station of the set of receiving stations to a second receiving station of the set of receiving stations. The mobile, dockable robotic apparatus 100 may be moved with the autonomous robot 1000, which can move the mobile, dockable robotic apparatus 100 by lifting and/or translating the mobile, dockable robotic apparatus 100. The autonomous robot 1000 can orient the mobile, dockable robotic apparatus 100 to allow subsequent coupling.

The process 1300 may continue at block 1306 by coupling the mobile, dockable robotic apparatus 100 with the second receiving station by engaging the mounting structure with the second receiving station. The mounting structure may be horizontally positioned in the second receiving station, vertically positioned in the second receiving station, or otherwise positioned in the second receiving station. The autonomous robot 1000 may engage the mounting structure with a tool changer and an input port of the second receiving station. The tool changer can be sized to receive the mounting structure, and the input port comprises an electrical input, a pneumatic input, and a data input. The process 1300 may continue at block 1308 by performing a robotic operation using the robotic manipulator 106 in which the robotic operation can be specific to a location associated with the second receiving station.

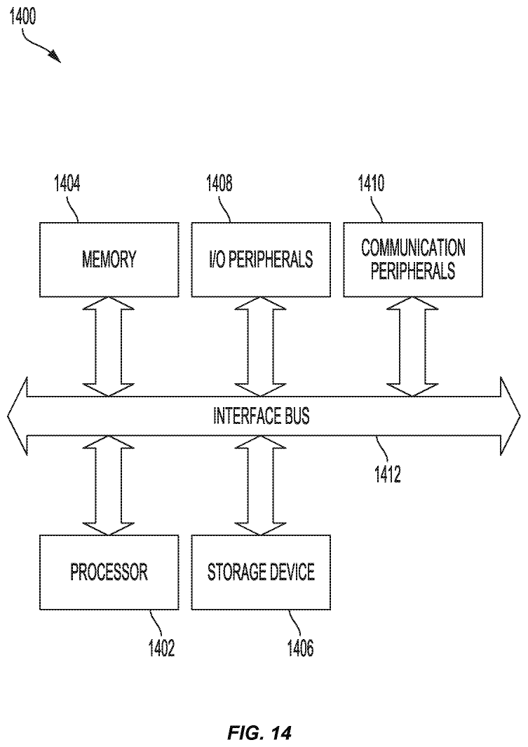

FIG. 14 illustrates examples of components of a computer system 1400, according to at least one example. The computer system 1400 may include a single computer such as a user computing device and/or can represent a distributed computing system such as one or more server computing devices. In some examples, the computer system 1400 may be configured to control the operation of one or more automated elements, such as robotic manipulators, conveyor belts, robotic palletizers, and any other automated equipment, of a warehouse, manufacturing facility, bottling facility, packing facility, etc.

The computer system 1400 may include a processor 1402, a memory 1404, a storage device 1406, input/output peripherals 1408, communication peripherals 1410, and an interface bus 1412. The interface bus 1412 may be configured to communicate, transmit, and transfer data, controls, and commands among the various components of the computer system 1400. The memory 1404 and the storage device 1406 may include computer-readable storage media, such as Radom Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 1404 and the storage device 1406 may include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 1400.

Further, the memory 1404 can include an operating system, programs, applications, and/or other software, models, modules, and the like. The processor 1402 may be configured to execute the stored instructions and includes, for example, a logical processing unit, a microprocessor, a digital signal processor, and other processors. The memory 1404 and/or the processor 1402 can be virtualized and can be hosted within another computing system of, for example, a cloud network or a data center. The input/output peripherals 1408 include user interfaces, such as a keyboard, screen (e.g., a touch screen), microphone, speaker, other input/output devices, and computing components, such as graphical processing units, serial ports, parallel ports, universal serial buses, and other input/output peripherals. The input/output peripherals 1408 may be connected to the processor 1402 through any of the ports coupled to the interface bus 1412. The communication peripherals 1410 may be configured to facilitate communication between the computer system 1400 and other computing devices over a communications network and include, for example, a network interface controller, modem, wireless and wired interface cards, antenna, and other communication peripherals.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. An apparatus comprising:
a cart having a device for allowing the cart to be mobile;
a robotic manipulator coupled with and extending from the cart, the robotic manipulator comprising an end effector for interacting with an item that is positionable at a receiving station; and
a coupling mechanism located on the cart, the coupling mechanism configured to couple the cart to a floor plate of the receiving station located on a floor of an operating environment for facilitating operation of the robotic manipulator, the coupling mechanism comprising a set of sensors to facilitate automatic execution of an operational mode of the robotic manipulator.

2. The apparatus of claim 1, wherein the set of sensors comprises a safety-rated proximity sensor, wherein the safety-rated proximity sensor is located on an underside of the cart, and wherein the safety-rated proximity sensor is arranged to engage with a corresponding safety-rated proximity sensor located on the floor plate.

3. The apparatus of claim 2, wherein the safety-rated proximity sensor is configured to engage with the corresponding safety-rated proximity sensor when the cart is successfully coupled with the floor plate, and wherein the operational mode is preventable when the safety-rated proximity sensor is not engaged with the corresponding safety-rated proximity sensor.

4. The apparatus of claim 2, wherein the safety-rated proximity sensor comprises a housing and a plurality of sections spaced apart within the housing, wherein each section of the plurality of sections is configured to interact with a corresponding section of the corresponding safety-rated proximity sensor, and wherein the safety-rated proximity sensor is engaged with the corresponding safety-rated proximity sensor when each section of the plurality of sections interacts with each corresponding section of the corresponding safety-rated proximity sensor.

5. The apparatus of claim 1, wherein the set of sensors comprises an identification sensor, wherein the identification sensor is located on an underside of the cart, and wherein the identification sensor is arranged to engage with a corresponding identification sensor located on the floor plate.

6. The apparatus of claim 5, wherein the identification sensor comprises an RFID transmitter that is configured to interact with the corresponding identification sensor to receive information about the receiving station, wherein the information comprises at least one of a location of the receiving station within the operating environment, a type of operation performable at the location, or a list of available operational modes at the location, wherein the identification sensor is communicatively coupled with a controller that is configured to operate the robotic manipulator, wherein the identification sensor is configured to transmit the information to the controller to facilitate a decision by the controller to automatically execute the operational mode, and wherein the operational mode is included in the list of available operational modes.

7. The apparatus of claim 1, wherein the set of sensors comprises a plurality of safety-rated sensors and an identification sensor, wherein a safety-rated proximity sensor of the plurality of safety-rated sensors and the identification sensor are located spaced apart on an underside of the cart to engage with corresponding sensors located on the floor plate, and wherein a safety-rated pressure sensor of the plurality of safety-rated sensors is located within a slot of the coupling mechanism to engage when a post from the floor plate protrudes into the slot to indicate when the cart is locked into the floor plate.

8. The apparatus of claim 1, wherein the device comprises a plurality of casters and a plurality of wheels, wherein wheels of the plurality of wheels are directionally fixed and positioned on an end of the cart configured to receive movement force, and wherein casters of the plurality of casters are directionally variable and positioned on an end of the cart opposite the end of the cart configured to receive the movement force.

9. The apparatus of claim 1, wherein the cart defines a plurality of lifting slots, wherein each lifting slot of the plurality of lifting slots is approximately parallel to other lifting slots of the plurality of lifting slots, wherein each lifting slot of the plurality of lifting slots is formed on an underside of the cart, and wherein the plurality of lifting slots are positioned around and spaced apart from the coupling mechanism.

10. The apparatus of claim 1, wherein the coupling mechanism comprises a restriction mechanism and a latching mechanism, wherein the restriction mechanism is configured to passively prevent lateral movement of the cart while the cart is coupled with the floor plate, and wherein the latching mechanism is configured to apply a coupling force to couple the cart with the floor plate.

11. The apparatus of claim 10, wherein the restriction mechanism comprises a plurality of posts, wherein each post of the plurality of posts extends below a bottom of the cart, wherein each post of the plurality of posts is arranged to slide into a corresponding slot of a plurality of slots of the floor plate, wherein the latching mechanism comprises a clamp that extends below the bottom of the cart between the plurality of posts, wherein the clamp is arranged to engage with a protrusion extending from the floor plate, and wherein the clamp is configured to apply the coupling force when engaged with the protrusion.

12. A system comprising:
a floor plate configured for mounting to a floor of a receiving station of an operating environment, the floor plate comprising a first coupling mechanism and a first set of sensors; and
a mobile robotic apparatus comprising:
a cart having a device for allowing the cart to be mobile;
a robotic manipulator coupled with and extending from the cart, the robotic manipulator comprising an end effector for interacting with an item that is positionable at a receiving station; and
a second coupling mechanism located on an underside of the cart, the second coupling mechanism configured to couple the cart to the floor plate of the receiving station, the second coupling mechanism comprising a second set of sensors to interact with the first set of sensors to facilitate automatic execution of an operational mode of the robotic manipulator.

13. The system of claim 12, wherein the first set of sensors comprises a first safety-rated proximity sensor, wherein the second set of sensors comprises a second safety-rated proximity sensor, wherein the first safety-rated proximity sensor is located on the underside of the cart, wherein the second safety-rated proximity sensor is located on a topside of the floor plate, and wherein the first safety-rated proximity sensor is arranged to engage with the second safety-rated proximity sensor located on the topside of the floor plate.

14. The system of claim 13, wherein the first safety-rated proximity sensor is configured to engage with the second safety-rated proximity sensor when the cart is successfully coupled with the floor plate, and wherein the operational mode is preventable when the first safety-rated proximity sensor is not engaged with the second safety-rated proximity sensor.

15. The system of claim 13, wherein the first safety-rated proximity sensor comprises a first housing and a first plurality of sections spaced apart within the first housing, wherein the second safety-rated proximity sensor comprises a second housing and a second plurality of sections spaced apart within the second housing, wherein each section of the first plurality of sections is configured to interact with a corresponding section of the second plurality of sections, and wherein the first safety-rated proximity sensor is engaged with the second safety-rated proximity sensor when each section of the first plurality of sections interacts with each corresponding section of the second plurality of sections.

16. The system of claim 12, wherein the first set of sensors comprises a first identification sensor, wherein the first identification sensor is located on the underside of the cart, wherein the second set of sensors comprises a second identification sensor located on a topside of the floor plate, wherein the first identification sensor is arranged to engage with the second identification sensor located on the topside of the floor plate, wherein the first identification sensor comprises a first RFID transmitter that is configured to interact with the second identification sensor to receive information about the receiving station, wherein the information comprises a location of the receiving station within the operating environment, a type of operation performable at the location, and a list of available operational modes at the location, wherein the first identification sensor is communicatively coupled with a controller that is configured to operate the robotic manipulator, wherein the first identification sensor is configured to transmit the information to the controller to facilitate a decision by the controller to automatically execute the operational mode, and wherein the operational mode is included in the list of available operational modes.

17. The system of claim 12, wherein the first set of sensors comprises a plurality of safety-rated sensors and an identification sensor, wherein a safety-rated proximity sensor of the plurality of safety-rated sensors and the identification sensor are located spaced apart on the underside of the cart to engage with corresponding sensors located on the floor plate, and wherein a safety-rated pressure sensor of the plurality of safety-rated sensors is located within a slot of the second coupling mechanism to engage when a post from the floor plate protrudes into the slot to indicate when the cart is locked into the floor plate.

18. The system of claim 12, wherein the first coupling mechanism comprises a first restriction mechanism and a first latching mechanism, wherein the second coupling mechanism comprises a second restriction mechanism and a second latching mechanism, wherein the first restriction mechanism and the second restriction mechanism are configured to passively prevent lateral movement of the cart while the cart is coupled with the floor plate, and wherein the first latching mechanism and the second latching mechanism are configured to apply a coupling force to couple the cart with the floor plate.

19. The system of claim 18, wherein the first restriction mechanism comprises a plurality of slots on a topside of the floor plate, wherein the second restriction mechanism comprises a plurality of posts, wherein each post of the plurality of posts extends below a bottom of the cart, wherein each post of the plurality of posts is arranged to slide into a corresponding slot of the plurality of slots, wherein the first latching mechanism comprises a protrusion that extends from the floor plate spaced apart from the plurality of slots, wherein the second latching mechanism comprises a clamp that extends below the bottom of the cart between the plurality of posts, wherein the clamp is arranged to engage with the protrusion and to apply the coupling force when engaged with the protrusion.

20. A method comprising:
decoupling a mobile robotic apparatus from a first receiving station of a plurality of receiving stations positioned on a floor of an operating environment, the mobile robotic apparatus comprising:
a cart having a device for allowing the cart to be mobile;
a robotic manipulator coupled with and extending from the cart, the robotic manipulator comprising an end effector for interacting with an item that is positionable at a receiving station; and
a coupling mechanism located on the cart, the coupling mechanism configured to couple the cart to a floor plate of the receiving station located on a floor of an operating environment for facilitating operation of the robotic manipulator, the coupling mechanism comprising a set of sensors to facilitate automatic execution of an operational mode of the robotic manipulator, the decoupling comprising releasing the coupling mechanism from the first receiving station;
moving the mobile robotic apparatus from the first receiving station of the plurality of receiving stations to a second receiving station of the plurality of receiving stations;
coupling the mobile robotic apparatus with the second receiving station by engaging the coupling mechanism with the second receiving station; and
performing a robotic operation using the robotic manipulator, wherein the robotic operation is specific to a location associated with the second receiving station.
